(19) United States
(12) Patent Application Publication
(10) Pub. No.: US 2008/0277896 A1
(43) Pub. Date: Nov. 13, 2008

(54) Swing Powered Scooter

(76) Inventors: Rocky Jenlon Lee, Artesia, CA (US); Li Lin Ni, Shanghai (CN)

Correspondence Address: Rocky Jenlon Lee, 17716 Belshire Ave., Artesia, CA, 90701, US

(21) Appl. No.: 11/745,452

(22) Filed: May 8, 2007

(51) Int. Cl. B62M 1/14

(52) U.S. Cl. 280/244

(57) ABSTRACT

The Swing Powered Scooter is to provide a transportation powered by hands instead of by feet. It has a handlebar on top of a swing pole, with a center point which is supported by an inner ring of a bearing on a board; Using pulling or pushing action drives wheels move, at same time, the handlebar steers in the forward direction. The bottom of the swing pole drives an increasing gear ratio mechanism; and by positioning an idler gear to change speeds or by 2 chains. Furthermore using a rack and a passive gear makes this invention is able to use pushing or pulling or both actions to make vehicle move forward.

### CROSS REFERENCE TO RELATED APPLICATION

This application claims the benefit of and priority from U.S. provisional application No. 60/818,245 filed on Jul. 3, 2006.

### BACKGROUND OF INVENTION

1. Field of the Invention

This invention relates to a scooter and a swing powered vehicle. By using a swing pole as leverage, it makes the vehicle move forward. A handlebar used to change the leverage pivot point, also it steers the forward direction. Furthermore, an increasing gear ratio mechanism and a special pushing and pulling mechanism make this invention an agile transportation apparatus.

2. Brief Description of the Prior Art

There are many types of scooters most of them are for recreational usage not for used as a means of transportation. Only a few models use the pulling action to make the scooter move forward, and even fewer models use pushing action to make vehicle move forward. The U.S. Pat. No. 6,311,998B1 Geared Scooter, which uses a connecting rod pulled by a handlebar, drives a planetary gear arrangement to increase the gear ratio then connects with a one-way mechanism to make rear wheel move. Since the handlebar swing stoke is limited by hand span, the bottom of the swing pole stroke will be proportionally reduced. The maximum useful stroke on a swing is only few inches. In addition, the scooter's wheel is only few inches in size. One pulling action could only move the wheel just few inches in distance even with a planetary gear arrangement. This speed is even slower than one push by foot on a regular scooter. Furthermore, their steering does not react as quickly as a bicycle; it can not respond to all different types of road situations. It is limited only for leisure usage, and not for transportation. Also, the Geared Scooter does not use a pushing action to move its vehicle.

### SUMMARY OF THE INVENTION

The purpose of this invention the Swing Powered Scooter is to provide a means of transportation which is powered by hands instead of by feet. It has a handlebar on top of a swing pole with a center point supported by an inner side of a bearing. By a pulling or pushing action, it drives the scooter to move, and also makes a turn by turning the handlebar. The bottom of the swing pole drives an increasing gear ratio mechanism, and it changes speeds by positioning an idler gear or by a two-chain arrangement. Furthermore, by a rack gear and a passive gear arrangement makes this invention move forward by pushing, pulling or both.

### BRIEF DESCRIPTION OF DRAWING

FIG. 1 shows a side view of a chain driving type of the Swing Powered Scooter.

FIG. 1-1 shows the swing pole with changeable pivot point and steering mechanism.

FIG. 1-2 shows the swing pole with a fixed pivot pin and steering mechanism.

FIG. 1-3 shows top view of a single front wheel type with steering gears.

FIG. 1-4 shows top view of a two-front wheel type with a steering arm.

FIG. 1-5 illustrates a side view of a swing pole stroke.

FIG. 2 shows a swing pole with a connecting rod and its passive gear type coupling mechanism.

FIG. 3 shows a swing pole with a rack gear and its passive gear type coupling mechanism.

FIG. 3-1 shows a swing pole at a different angle with a rack gear and its passive gear.

FIG. 3-2 shows a front view of a rack gear and its passive gear arrangement.

FIG. 4 shows top view of an increasing gear ratio mechanism.

FIG. 5 shows a side view of a rack gear type, driving by both pulling and pushing force.

FIG. 5-1 shows a top view of a rack gear type, driving by both pulling and pushing force.

FIG. 6 shows a side view of this invention on a two-chain type coupling mechanism application.

FIG. 6-1 shows a top view of a two-chain type coupling mechanism on two-rear wheel application.

FIG. 6-2 shows a top view of a two-chain type coupling mechanism on single rear wheel application.

### DRAWING NUMBER LIST

1 Swing pole, 2 Pivot center, 3 Front wheel, 4 Swing pole bottom end, 4a Connecting rod, 4b Connecting pin, 4c Passive gear, 4d Passive gear shaft, 5 Board, 5a Rack, 5b Passive gear, 5c Idler, 5d Idler shaft, 5e Passive gear shaft, 5f Connecting plates, 5g Frame board, 5h Output gear, 5i Extension gear, 7 One-way device, 8 Rear wheel, 8a One-way gear, 8b Gear, 8c Gear, 8d Shaft, 8e Idler gear, 8f Last gear, 8g Rear where shaft, 8h Shaft, 8i One-way gear, 8j One-way gear, 8k Idler, 81 Shaft case, 8m Shaft, 9 Returning spring, 10 Pulling matter, 11 Front guide roller, 12 Increasing gear ratio mechanism, 13 Drive shaft 14 Handlebar, 15 Rear guide roller, 16 Steering shaft, 17 The input gear, 18 Big gear, 19 Small gear, 20 Big gear, 21 Small gear, 22 Big gear, 23 Keyed gear, 24 Shaft, 25 Keyed gear, 26 Output gear, 27 Bearing, 28 Pivot pin, 29 Swivel pipe sleeve, 30 Inner ring, 30a Outer ring, 31 Steering linkage, 31a Steering gear, 31b Idler, 31c Steering gear, 31d Steering arm, 32 Upper limiter, 33 Lower limiter, 44 Chain 45 Spring 46 One-way gear, 47 High gear, 48 Gear, 49 Rear wheel shaft, 50 Chain, 51 Slack loop, 52 Low gear, 53 One-way gear, 54 Bottom short stroke, 55 Bottom long stroke, 56 Gear, 57 Gear, 58 Gear, 59 Gear, 60 The Swing Powered Scooter, 61 Front wheel assembly, 62 Coupling mechanism, 63 Rear wheel assembly.

### DETAIL DESCRIPTION OF THE INVENTION

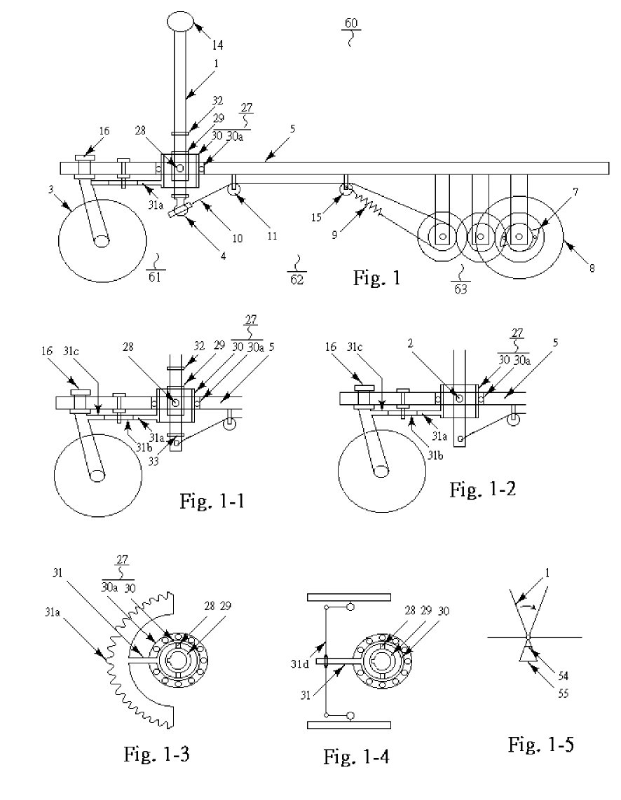

Refer to FIG. 1, a Swing Powered Scooter 60 consists of a board 5 with a front wheel assembly 61 having steering mechanism at the front end; a rear wheel assembly 63 containing an increasing gear ratio mechanism 12 with a one-way device 7 at rear end; a handlebar 14 at top of a swing pole 1 which has a leverage pivot point on the board 5, also, the handlebar links to the steering mechanism of the front wheel assembly 61 for steering; a coupling mechanism 62 connects bottom side 4 of the swing pole 1 to the increasing gear ratio mechanism 12. Using leverage on handlebar 14 pushing forward and pulling back, the bottom side 4 of the swing pole 1 drives the increasing gear ratio mechanism 12 of rear wheel assembly 63 to make the board 5 move forward.

The rear wheel assembly 63 includes a one-way device 7 to drive rear wheel(s) 8 and the increasing gear ratio mechanism 12 which consists of many sets of one big gear with one small gear together acting as one set, each set rotates freely on shaft; and continues with many sets in serial engaging arrangement of one big gear meshing to another set's small gear, and that small gear with a big gear which meshes to a different set's small gear, and this arrangement continues until the last gear which drives a one-way device 7 on the rear wheel shaft to turn the rear wheel(s). All gear shafts are free rotating and are supported on the board 5. This allows a gear to connect to another gear through keyed gears on same shaft. Refer to FIG. 4. The figure shows an example of an application of same size gear set on two gear shafts with input and output, both by near the center area. A driving force comes to the driving shaft 13 around the center area of the increasing gear ratio mechanism 12, and input to gear 17 on shaft 13 and that gear 17 is one part with a big gear 18 as a gear set. Then this big gear 18 drives another set's small gear 19 on shaft 24 just as big gear 20 drives another set's small gear 21 with a big gear 22 attached. This continues until it reaches gear 23 at shaft 24. This gear 23 is fixed with the shaft 24 by a key, and shaft 24 drives another big gear 25 which is fixed on the other side of the shaft 24 by a key. This big gear 25 drives a small gear that is attached to a big gear on shaft 13. This continues to increase gear ratio until the last output gear 26 that is near the center of the shaft 24. The output to the one-way device on rear wheel shaft makes rear wheel(s) move. The one-way device 7 is like a rear shaft's one-way gear on a bicycle. So eventually, the last gear 26 drives the rear wheel at a very high speed.

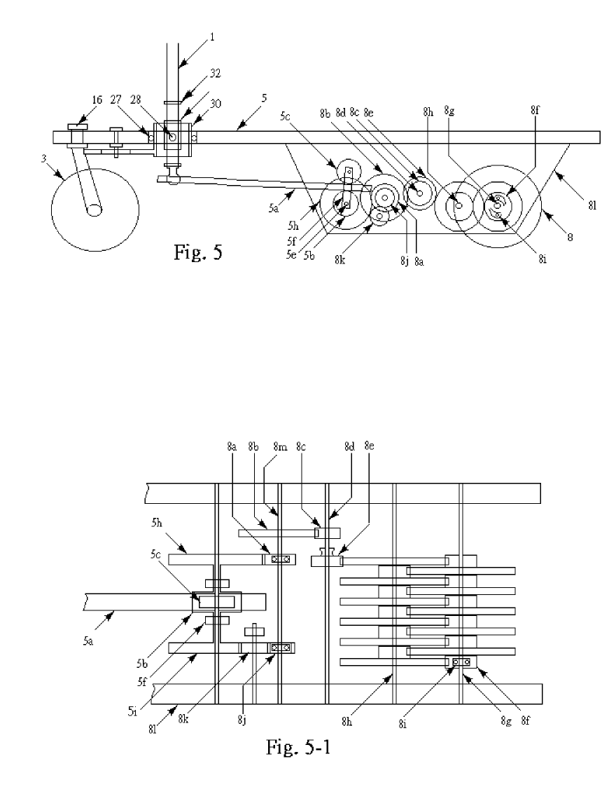

The front wheel assembly 61 includes turning wheel(s) 3 and steering mechanism which is controlled by the handlebar 15 and swing pole 1 for turning direction. Presently there are many prior art steering mechanisms to steer a scooter; commonly by tipping left or right on the handlebar with body weight or by turning the handlebar with hands. Refer to FIG. 1-1. The bottom part of the swing pole 1 with a long key or spline goes through a swivel pipe sleeve 29 which has matching shape slot inside the pipe sleeve 29. Refer to FIG. 1-3. The pipe sleeve 29 has a pair of pivot pins 28 at both sides, pivotally fixed on an inner ring 30 of a bearing 27. Normally, a bearing has an inner part rotating on its outer part. This bearing 27 can be any type or form, such as ball bearing, roller bearing, bushing, a hollowed turning shaft or any type of pivotal connection. And vise versa, the two pivot pins 28 can be fixed on the inner ring 30 of the bearing 27 and engaged into a pair of pivotal holes on both side of the pipe sleeve 29 or into a pair of slots on both side of the pipe sleeve 29 with a nut on pipe sleeve to lock both pins in the slots. The bearing's outside ring 30a is fixed on the board 5 or as one part of the board 5. The swing pole 1 can be swiveled back and forth by two pivotal pins 28 for swing action, and it is able to turn left or right on bearing 27 for turning direction by the key or spline in the pipe sleeve slot. The swing pole slides up and down inside of the swivel pipe sleeve 29 to change the leverage center and stroke span as FIG. 5-1 shown. There are two stop rings 32 and 33 to limit the swing pole's up and down range. Swing pole 1 may have retractable locking pins which lock into same interval locking pin holes located inside of the swivel pipe sleeve, working the same way as a traveler's handy rolling case. Pushing a pushbutton on handlebar will retract all locking pins allowing it to adjust to a different pivot center for a different leverage ratio, as if shifting a gear. Also, a telescopic function can be used to change handlebar height for more leverage.

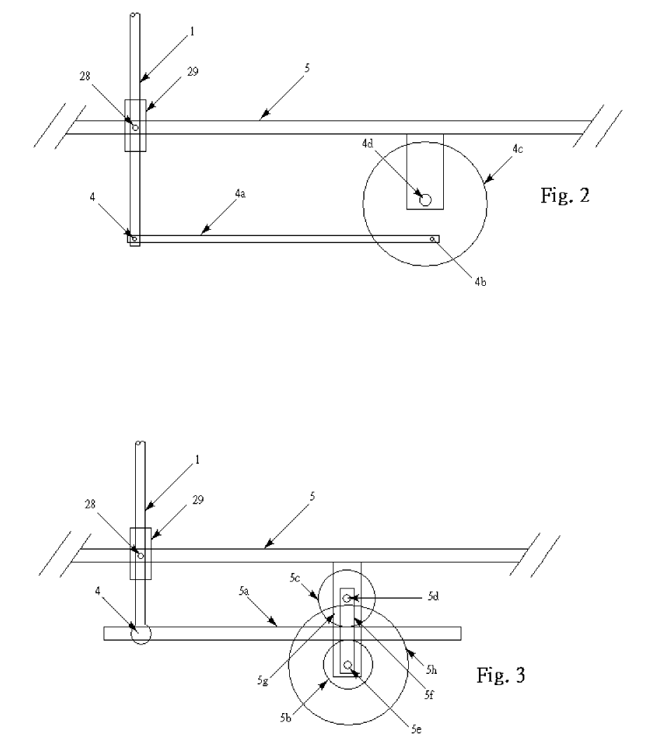

Refer to FIG. 1-2; it combines the swing pole 1 and the pipe sleeve 29 as one part. One pivotal pin 2 goes through the swing pole's pivotal hole and the pin is mounted on the inner ring 30 of the bearing 27. The pivotal pin 2 lay down and both ends are fixed across on the inner ring 30 of the bearing 27. There is a bushing between the swing pole portion and the pivotal pin portion. The bearing 27 outside ring 30a is fixed on front side of the board 5.

The bearing's inner ring 30 supports the swing pole's pivotal point and it also links to the steering mechanism which steers the front wheel 3 on the front wheel assembly 61. Many arrangements can link the bearing's inner ring 30 to the front wheel's turning shaft, such as FIG. 1-3 shows a single front wheel application or as FIG. 1-4 shows a two-front wheel application. The inner bearing contains a steering gear 31a, or the inner bearing tight fits with a hollowed shaft (not shown) which has a steering gear 31a, in mesh with an idler gear 31b on the board; the idler 31b meshes with a front wheel gear 31c to turn front wheel 3 on front wheel's turning shaft 16; also the idler gear 31b can be replaced by a belt or a chain between steering gear 31a and front wheel gear 31c. FIG. 1-4 shows a two-front wheel application; the inner bearing 30 has a steering arm 31 linking with the front side half of the parallelogram-steering mechanism, like a car's steering application to turn its front wheels. The steering gear 31a or steering arm 31 which is in the bearing's inner ring 30 can be bonded in many ways; or as one part together; or linked by many kinds of driving means.

The board 5 is for a user to stand on and to swing the handlebar. It contains the front wheel assembly 61, a bearing 27 to support the swing pole pivot at front side and the rear wheel assembly 63 at back side.

The coupling mechanism 62 connects between the bottom 4 of the swing pole 1 and the input gear of the increasing gear ratio mechanism 12 which will be referred to as the input gear 17 hereafter. The coupling mechanism 62 can be many types of driving means: a chain type, a connecting rod or a rack gear type; it further contains different types of the gear-shifting devices such as: a shuttling idler gear type or a two-chain type as follows.

As FIG. 1 shown, the bottom 4 of the swing pole has a ball joint connecting a chain 10 which encircles the input gear 17 and is held back by a return spring 9 which is fixed on the board. When the handlebar is pulled back, it will make the input gear 17 turned. This makes the one-way device 7 turning and the board 5 moves forward and coast. The spring 9 pulls back when the handlebar is pushed forward to reset cycle while one-way device 7 allows the board to keep coasting. The chain 10 hereafter can be many forms, like a steel wire, a nylon string or a timing belt, etc. The return spring 9 also can be a coil spring held on the shaft support.

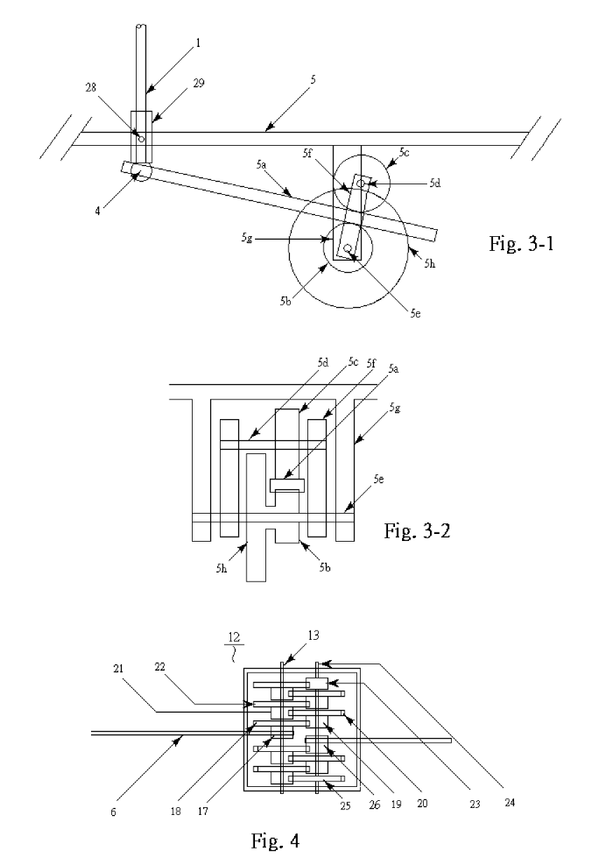

In order to use a pushing force, as FIG. 2 shown, a pin or ball joint at bottom 4 of the swing pole connects to a connecting rod 4a; the other side of the connecting rod connects on the edge of a passive gear 4c by a pin 4b. By pulling or pushing, the passive gear 4c rotates back and forth accordingly. The passive gear shaft 4d is fixed on the board 5. The output of the passive gear 4c is connected to the input gear 17. Also, as FIG. 3 shows, (FIG. 3-2 is a front view), the bottom 4 of the swing pole has a ball head joint connecting to a rack gear 5a, and then the other side of the rack gear meshes with a passive gear 5b with a output gear 5h together. At opposite side of the passive gear 5b, there is an idler 5c pressing on the rack gear 5a to keep rack gear 5a meshing with the passive gear 5b at all time. The idler shaft 5d is supported by a pair of connecting plates 5f, and connecting plates 5f are pivotally fixed on the passive gear shaft 5e. The passive shaft 5e is supported by a pair of board plates 5g which are fixed on the board 5. When the rack gear 5a moves back and forth, the passive gear 5b rotates back and forth accordingly. As FIG. 3-1 shows, if the rack gear's one end moves up and down followed by the swing pole 1, the connecting plates 5f will swivel at an angle base on the passive gear shaft 5e to adjust the up and down angle automatically, and keeping the output gear 5h meshed with the input gear 17 at all times without any interruption. When swing pole 1 moves back to reset on a cycle, the one-way device 7 on rear wheel shaft will allow a rotation backwards for next action cycle. So it just changes the output gear's rotation direction, like adding one idler gear, it will change from a pulling action type scooter to a pushing action type scooter.

Theoretically, it needs approximately a 55-time increase gear ratio in order to make a 4-inch wheel generate 12.5 mile per hour speed from the bottom side of a swing pole with 4 inch stroke per second; and it needs over hundred times gear ratio to speed up to 25 miles per hour. Although the adjustable pivot leverage could adjust to over hundred times the torque on the swing pole 1, and generate any leverage as needed, it will put too much stress on the gears and shafts in the increasing gear device at start-up and cause teeth skipping or collapsed teeth on the gears, so it needs a low gear ratio to overcome the start-up situation. If on same condition, it needs only 5.5 time gear ratio or torque if speeds are reduced to 1.25 miles per hour, and its max stress will be a greatly reduced. Thus the coupling mechanism 62 also includes a gear shifting device as FIG. 5-1 shows; an idler gear 8e with spline inside makes an axial movement on a driving shaft 8d, by a fork (not shown) chucking on idler groove and controlled by two wires (not shown) holding from both sides. The two wires link to a gear shifting index handle, like a bicycle's speed selector which locks the shifting wires in different length at many positions, to positioning said fork at a specific place making the idler gear 8e positioned at a desired input gear on the input shaft 13 of the increasing gear ratio mechanism 12. Also, axial movement may be moved by a centrifugal force according to forward speed. The idler driving shaft's power comes from connecting element such as: a chain 10, the rack gear 5a or connecting rod 4a.

Refer to FIG. 5 and FIG. 5-1, the output gear 5h drives a one-way gear 8a, also the output gear 5h has a same size extension gear 5i at the other side of the same shaft. This extension gear 5i changes the rotation direction by meshing with an idler gear 8k whose center shaft is supported by the board 5, and then drives another one-way gear 8j. (Also 5i can be chained with 8j directly to change the rotation direction) Both two one-way gears 8a and 8j are on same shaft, and drives one-way on its shaft 8m and the 8m is keyed with the gear 8b to drive shaft 8d through a gear 8c. This will enable the swing pole to both pull and push. When pushing, the pushing side's one-way gear 8a drives its shaft 8m, and the shaft 8m turns gear 8b which is fixed on its shaft 8m. Meanwhile, the pulling one-way gear 8j rotates backward to reset its cycle. The gear 8b drives gear 8c which is fixed on a spline shaft 8d. There is an idler gear 8e with a fork groove and slides on the spline shaft 8d. The idler gear 8e slides on the spline shaft by a fork (not shown), it positions to a different gear ratio on the increasing gear ratio mechanism 12. Last gear 8f has one-way device 8i to drive rear wheel. All other gears rotate freely on their shaft. When swing pole stop at end of each swing stroke, all gears also will stop, except shaft 8g still coasting, this makes the idler gear 8e easy to engage into a different gear. Because idler gear's position at different gear set makes more or less gears increase the gear ratio; it changes the rear wheel's speed. Same with the pulling cycle; pulling the one-way gear 8j drives the power, while the push type one-way gear 8a reset its cycle, and the cycle continues.

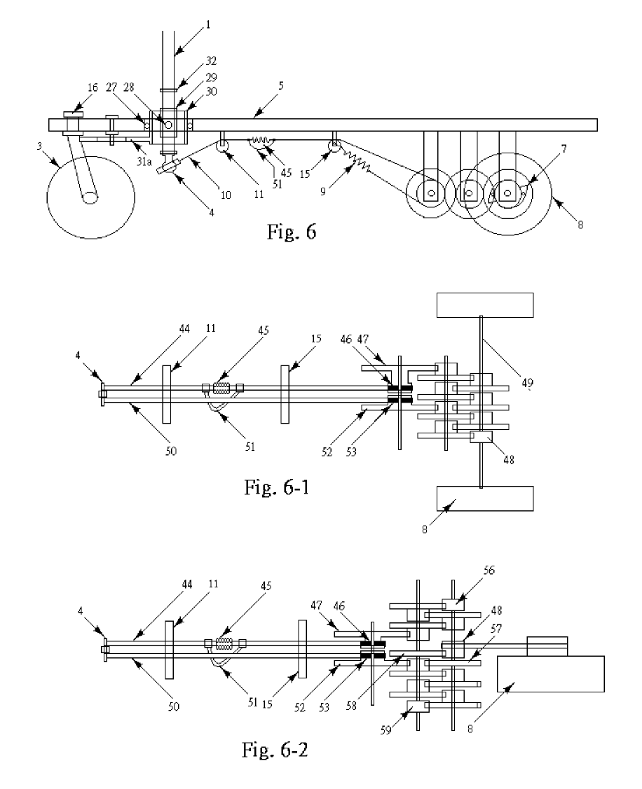

Refer to top view FIG. 6-1, on a two-rear wheel application, all gears are running freely on their shafts except the last one, gear 48, which one-way drives shaft 49 to drive the rear wheel. The bottom 4 of the swing pole 1 connects two pulling chains, 44 and 50, to sprockets 46 and 53 respectively, and each is held by its return spring 9 to rest cycle. Sprocket 46 drives gear 47 which connects at the beginning of the increase gear ratio mechanism, refers as high gear. Sprocket 53 drives gear 52 which connects at one of middle gear set of the increasing gear ratio mechanism, refers as low gear. Sprocket 46 and 53, each has a one-way device inside to connect gear 47 and 52 respectively. This separates the sprockets, gears 47 and 52; they all can run at different speeds as long as gears 47 and 52 are faster than sprocket 46 and 53. Sprocket 46 and 53 may be stopped while gears 47 and 52 are still running. Chain 44 has a slack loop 51 and is held by spring 45. The loop length could be set as half of the swing stroke, and spring 45 could set at a certain force which is enough to drive a high speed. This prevents an infinity inner stress, damaging the gears during a start-up condition. Spring 45 will yield when it pulls a heavy overload. Chain 50 does not have any slack loop; the same pulling force pulls sprocket 53 through the one-way gear and drives gear 52 immediately at a low-speed high torque. The last gear 48 drives shaft 49 to rear wheels. The rear wheels move immediately at a lower speed gear because force starts from one of middle gear set of the increasing gear ratio mechanism. This will create less stress on the gears compared to all the force coming from the beginning gear. The scooter will move by a low speed gear force plus the high speed gear force from the loop spring at the first-half swing span.

Furthermore, as FIG. 1-5 shows, the handlebar's up or down movement to change torque and stroke 54 and 55. It will give more selection to the user to maneuver the scooter. The low speed gear will gradually lose it function when it reaches a higher speed. The loop is straightened during last half of swing stroke, allows an individual user to achieve its own maximum speed. FIG. 6-2 shows a single rear wheel application. Gear 59 and 58 are keyed on same shaft; gear 56 and 57 are keyed on another shaft. It works the same way as described before, the power from the high speed gear 47 to gear 56, then through the shaft to gear 57, and parallel connected with the low speed gear 52; and continues to gear 59, through the shaft to gear 58, then gear 48 output to rear wheel. Furthermore, for easy storage, the swing pole 1 can be separated into two pieces, and re-joined by threading or by a connection like the Quickly Release Air Fitting. Also a connecting rod type swing pole, bend on its pivot point and straighten by a pipe which slides back to hold the pivot point. Compared to a bicycle, a scooter's wheels are very small. The wheels of this invention are not limited to being under the board 5. They can use curved-up shapes on the board at wheel side to accommodate bigger wheels even wheel centerline is above the board height. Also this would allow wheel suspensions, brakes, etc. The application used in this invention the Swing Powered Scooter, can be applied to any hand swing powered rolling vehicle such as a scooter, a four-wheel quad vehicle, a snow vehicle or a rail service cart.

1. A Swing Powered Scooter is comprised of:
a board;
a front wheel assembly with a steering mechanism to change direction at front end of said board;
a rear wheel assembly with a one-way device to drive rear wheel(s) at rear end of said board, and connecting an increasing gear ratio mechanism;
a handlebar on a swing pole with a leverage pivot on said board and also links to said steering mechanism to turn front wheel(s); and
a coupling mechanism connecting power between the bottom of said swing pole and said increasing gear ratio mechanism;
wherein said increasing gear ratio mechanism which comprises of many sets of one big gear together with one small gear as a unit set; each set rotates freely on its shaft, and continues many sets in serial engaging arrangement of one big gear meshing with another set's small gear and that small gear's big gear meshed to a different set's small gear till the last gear and drives said one-way device on the rear wheel shaft to make said board move forward.

2. A Swing Powered Scooter, as claimed in claim 1 wherein said coupling mechanism contains an idler gear with spline inside which slides on a driving shaft and positioning on different spots to connect the bottom of said swing pole's diving force to a gear on input shaft of said increasing gear ratio mechanism to change to a more or less gear ratio.

3. A Swing Powered Scooter, as claimed in claim 1 wherein said coupling mechanism contains two pulling matter at bottom of the swing pole, one just little longer than another, each pulling matter in an engaging way by encircled its own one-way device which coupled to one gear of said increasing gear ratio mechanism then in serial with a return spring held on the board; the longer one pulling matter has a little loop held by a spring and its one-way device drives at the being gear of said increasing gear ratio mechanism, another one-way device drives at one of middle gear of said increasing gear ratio mechanism.

4. A Swing Powered Scooter, as described in claim 1, further comprising: the bottom part of said swing pole has a long key or spline, which slides up and down in a pipe sleeve with same shape slot and the outside wall of said pipe sleeve pivotal supported by an inner ring of a bearing, and said inner ring also has a linkage connecting to said steering mechanism to turn the front wheel(s); and the bearing's outside ring is fixed on the front side of said board.

5. A Swing Powered Scooter, as claimed in claim 4, wherein said swing pole and said pipe sleeve are combined as one part and makes said swing pole having one pivotal pin which is supported by said inner ring of said bearing.

6. A Swing Powered Scooter, as claimed in claim 4, wherein said coupling mechanism containing a rack gear at the bottom of the swing pole and another side of said rack gear meshes with a passive gear which drives said increasing gear ratio mechanism; wherein said rack gear at the opposite side of said passive gear has an idler pressing on said rack gear and said idler shaft is held by a pair of connecting plates, said connecting plates are pivotally fixed on the passive gear shaft, said passive gear shaft is supported on said board.

7. A Swing Powered Scooter, as claimed in claim 6 wherein said passive gear drives two same direction one-way gears; one with a straight drive and another which changes direction before driving another one-way gear, and two one-way gears, both driving the input of said increasing gear ratio mechanism.

8. A Swing Powered Scooter, as claimed in claim 4, wherein said coupling mechanism containing a connecting rod at the bottom of said swing pole, and the other side of said connecting rod pinned on the edge of a tandem passive gear and said passive gear drives said increasing gear ratio mechanism.

9. A Swing Powered Scooter, as claimed in claim 8 wherein said passive gear drives two same direction one-way gears; one with a straight drive and another which changes direction before diving another one-way gear, and two one-way gears, both driving the input of said increasing gear ratio mechanism.
